(19) United States
(12) Patent Application Publication
(10) Pub. No.: US 2006/0277096 A1
(43) Pub. Date: Dec. 7, 2006

(54) Method and system for providing technical services

(76) Inventor: Robert A. Levitus, Austin, TX (US)

Correspondence Address: FORTKORT GRETHER & KELTON LLP, 9442 N. Capital of Texas Hwy., Arboretum Plaza One, Suite 500, AUSTIN, TX, 78759, US

(21) Appl. No.: 11/143,913

(22) Filed: Jun. 2, 2005

(51) Int. Cl. G07G 1/14

(52) U.S. Cl. 705/14; 714/25

(57) ABSTRACT

A method is provided for remote near real time technical services. The method includes but is not limited to receiving a request for technical services; routing the request to a technical services control center; determining at the technical services control center availability of one or more technical service providers for providing services; servicing the request via a collaboration of the technical service providers or an individual technical service provider according to the requirements of the request wherein the collaboration is via a near real time data link; searching a data store for a most likely solution appropriate for the machine issue; and after servicing a machine, updating the data store.

### FIELD OF THE INVENTION

This invention pertains to providing computer-related technical services and, more particularly, to a method and system for providing near real time remote computer-related technical services.

### SUMMARY

A method and system are provided for remote near real time technical services. The method includes but is not limited to receiving a request for technical services; routing the request to a technical services control center; determining at the technical services control center availability of one or more technical service providers for providing services; servicing the request via a collaboration of the technical service providers or an individual technical service provider according to the requirements of the request wherein the collaboration is via a near real time data link; searching a data store for a most likely solution appropriate for the machine issue; and after servicing a machine, updating the data store.

### BACKGROUND

Current technical support available for computer systems for individuals is available via consumer stores such as CompUSA, Best Buy and local computer centers that require individuals to bring their computers to a store location. Online technical support is also available via computer manufacturer websites. The online help available varies widely among manufacturers. One on-line method requires customers to perform a keyword search to identify a problem encountered and then identify a document that may or may not pertain to a problem encountered with a computer system. If a problem cannot be resolved, a customer may be asked to contact a toll-free customer help desk or to purchase software or hardware to fix the problem.

### BRIEF DESCRIPTION OF THE DRAWINGS

For a more complete understanding of the present method and system for storing and retrieving self-descriptive tabular data having both alphanumeric and binary values, reference is now made to the following description which is to be taken in conjunction with the accompanying drawings and in which like reference numbers indicate like features and further wherein:

FIG. 1 illustrates an exemplary system that provides a suitable operating environment for the present invention;

FIG. 2 illustrates a network environment appropriate for implementing embodiments of the present invention;

FIG. 3 is a flow diagram that illustrates a method in accordance with an embodiment of the present invention.

FIG. 4 is a flow diagram that illustrates a method in accordance with an embodiment of the present invention.

### DETAILED DESCRIPTION OF THE ILLUSTRATIVE EMBODIMENTS

Preferred embodiments of this invention are described herein, including the best mode known to the inventor for carrying out the invention. Variations of those preferred embodiments may become apparent to those of ordinary skill in the art upon reading the following description. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

The inventor expects skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

According to one aspect of the invention, there is provided a method for providing remote technical services, including support for individual computer users in near real time.

The present invention incorporates enables a user to download a computer software application via a network connection. Using the downloaded software application, the user's computer becomes operable by a computer technician capable of resolving the user's technical issues.

An embodiment is directed to combining the technology of the software application's ability to seamlessly resolve computer issues of the user with recording technology to enable bundling the ability to supply technical support with providing a recording of the interaction with the user by providing a video of the session between the technician and the user. Numerous recording software packages exist which can provide recording technology to implement combining technical support with providing a recording of the session to benefit users with, for example, recurring similar or same problems with their computer systems. Accordingly, the benefits of the combined technical support and recording bundle formed according to the teachings of the present invention may be realized in a wide variety of ways.

As described below, the technical support and operating system used to encompass the embodiments can be described herein in terms of one or more operating systems, and it is understood that other operating systems, such as Linux, or Windows operating systems or the like may be used as described herein.

The present invention extends to methods, systems, and data structures for enabling a technician to provide near real time remote support for users across a plurality of communication types. The embodiments of the present invention may comprise one or more special purpose or general purpose computers including various computer hardware devices, as discussed in greater detail below. As used herein, a “memory,” “recording medium,” and “data store” may be any means that contains, stores, communicates, propagates, or transports the program and/or data for use by or in conjunction with an instruction execution system, apparatus or device. For example, memory, recording medium and data store may be, but are not limited to, an electronic, magnetic, optical, electromagnetic, infrared or semiconductor system, apparatus or device. Memory, recording medium and data store may also include, but are not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that several of the acts and operation described hereinafter may also be implemented in hardware.

Embodiments within the scope of the present invention also include computer-readable media for carrying or having computer-executable instructions or data structures stored thereon. Such computer-readable media may be any available media which may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which may be used to carry or store desired program code means in the form of computer-executable instructions or data structures and which may be accessed by a general purpose or special purpose computer.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

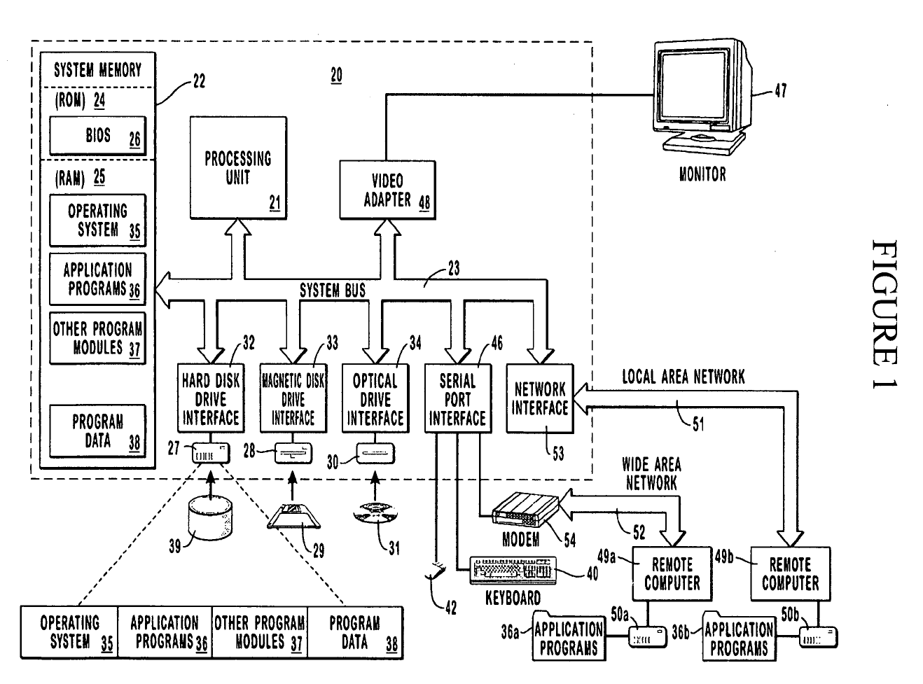

FIG. 1 and the following associated description intend to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc., that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data may be used, including magnetic cassettes, flash memory cards, digital video disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more software application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated software application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

Generally, the present invention provides a method and system for providing remote near real time technical support to users over any one of a plurality of communication connections. For example, communication can occur over the Internet, over phone lines or other methods because the present invention does not limit the type of communication used and provides a framework for flexible use of communication methods to provide use of remote computer software applications and systems for technician use. By enabling interactive communication instead of requiring a user to self-diagnose computer issues, a more flexible and maintainable technical paradigm occurs. This more flexible and maintainable technical paradigm combined with a model that allows a user to request support for a variety of technical issues in one session beneficially tackle multiple issues with one remote session.

The present invention allows combining in a single technical support session expertise from a variety of technical experts that can be themselves remotely located. More specifically, technical experts can be remotely connected via a chat protocol or other near real time sharing protocol that enable multiple computers to operate one or more same software applications residing on the user's computer. Technical service providers can also share software applications residing one or more technicians' computers to enable recreating or observing the user issues.

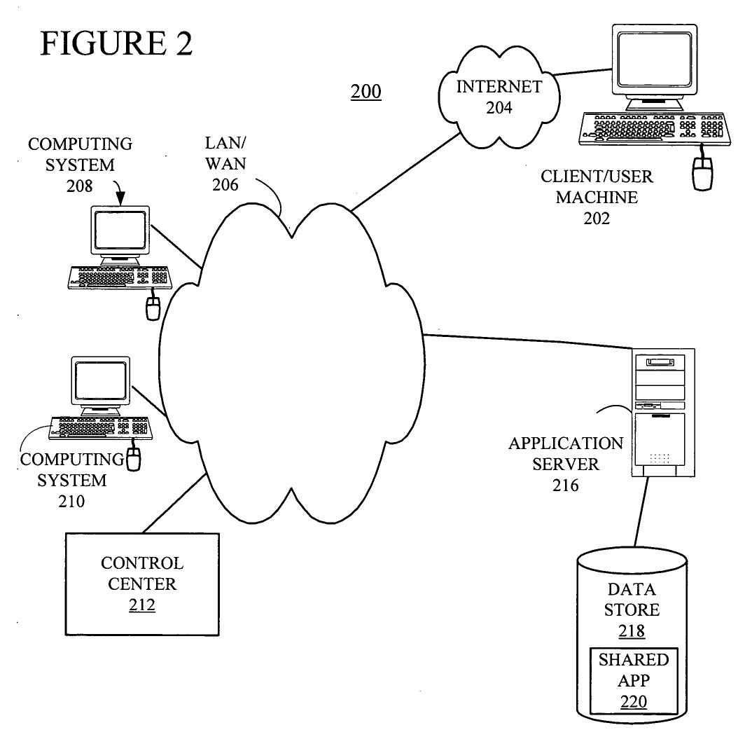

Referring now to FIG. 2, an exemplary network environment illustrates how data transmission and technical services can be provided in accordance with embodiments of the present invention. As shown, network 200 includes at least one client machine 202, which can be coupled to the internet 204 via a broadband connection. Internet 204 is shown coupled to LAN/WAN 206. LAN/WAN 206 is shown coupled to computing systems 208 and 210, which can be computing systems used by technical service providers who could provide services to a user of client machine 202, for example. Also shown coupled to LAN/WAN 206 is control center 212, file server 214 and application server 216. Application server 216 can be coupled or include data store 218, which can also hold shared applications 220. According to an embodiment, control center 212 can be included as an operating function of computing systems 208 or 210 or included in an appropriate server if an appropriate input/output connection is provided as will be appreciated by one of skill in the art. Control center 212 can be configured to receive requests from users of a client machine 202 and respond via a web interface or other broadband connection. Control center 212 can also be configured to respond to telephone calls, instant messages via a chat application, and the like. Control center 212 can be configured to interact with a plurality of technical service providers, users via client machines and the like as a central hub for providing a central location to which service providers from many locations can log in. For example, a virtual private network (VPN) service could be incorporated to allow technical service providers to log in remotely to the control center to interact via one of many protocols. Additionally, control center 212 can be configured to intercept communications between technical service providers to enable logging of each communication between users and a technical service provider. To this end, the communication between technical service providers and users can be configured to enable the control center to implement screen sharing and recording software present on a client machine, record any interactions between technical service providers and users and enable creation of a recording to be provided to a user, as explained in more detail below.

Additionally, control center 212 can be configured to direct a user to install software to enable enhanced features such as screen sharing and the like. The interaction with a user can be automatic to a point at which a technical service provider is required, needed or requested. For example, a user at client machine desiring technical services may require applications to be installed on his or her machine prior to being able to have the interaction with a technical service provider desired. Control center 212 can be configured to direct the user to an application file server, such as application server 216 to enable downloading of appropriate software, such as screen sharing software. Control center 212 can further be configured to enable a user to choose services desired and effect payment upon making a choice. Control center 212 can be configured to be interactive to enable user to make choices and respond accordingly. Further, interaction with control center 212 can be via telephone or via an internet connection. In one embodiment, control center 212 can receive user requests via data entry processing of facsimile transmissions, letters or other communication methods for which data entry is appropriate.

FIG. 2 illustrates that control center 212 is coupled to LAN/WAN 206, which is also coupled to an application server 216. Control center 212 could also be coupled directly to a server, or be incorporated into a server.

FIG. 2 further illustrates application server 216 coupled to a data store 218 and shared applications 220. In one embodiment, control center 212 is configured to interact with data store 218 to retrieve data via a search for information. More specifically, in an embodiment, a technical service provider interacting with a user, either directly or via control center 212, can have access to data store 218 to perform searches of relevant information if necessary to assist a user with an issue on client machine 202. Data store 218 can be configured to hold technical data organized as a neural network to enable on-the-fly enhancement of the data. The enhancement can improve a search engine operable with the data store and can be configured with artificial logic to self-enhance the data available to technical service providers. In one embodiment, data store 212 is visible to several technical service providers simultaneously, the technical service providers working on a same or different client machine. More particularly, in an embodiment, data store can hold data related to technical service issues as well as applications to be made available to technical service providers and client/user machines 202.

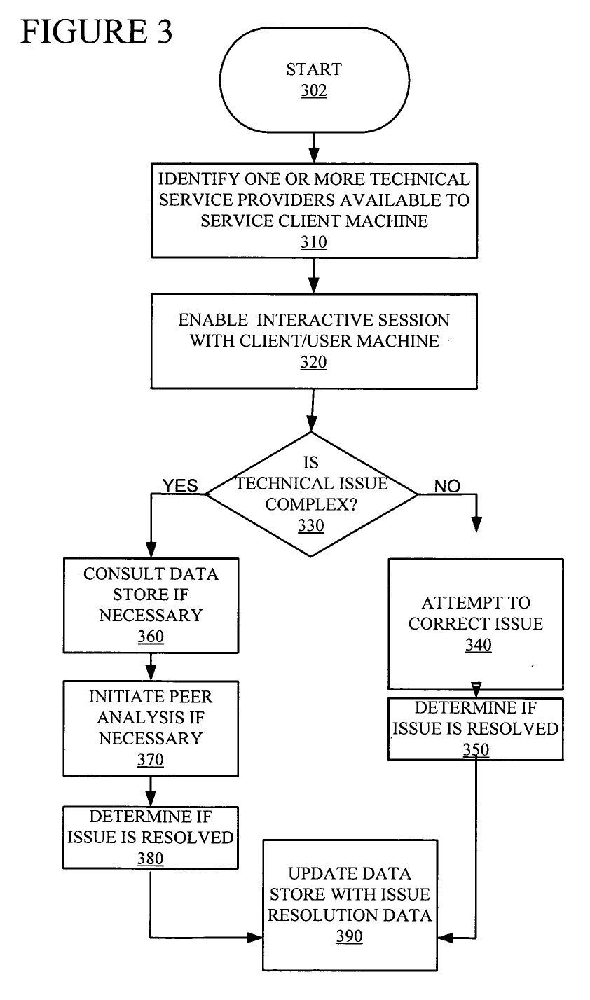

Referring now to FIG. 3, an embodiment is directed to a method illustrated in a flow diagram. Block 302 provides for starting the method. For example, the presence of a software issue in a client/user machine 202 requiring technical assistance could result in a user contacting a service via a telephone call or web interaction. More particularly, a user with an issue contacting a website for technical assistance can identify either a software, hardware or other issue with a machine, and contact the service to begin a method. Block 310 provides for identifying one or more technical service providers available to service the machine. Thus, after a service request has been made and appropriate authorization has been made, immediate service can be enabled. Appropriate authorization could include logging into a user account that identifies the user machine and verifies a service agreement that is up to date and paid for. Appropriate authorization could also include setting up an account for either a one time service, a package of servicing time, or a regular service plan lasting a predetermined duration.

Block 320 provides for enabling an interactive session with the client/user machine. To enable an interactive session, a website connection can provide links to enable a user to download software if not present on a machine. More particularly, a link could couple a user via internet 204 to LAN 206 to application server 216 which can host shared applications and enable downloading of software. Additionally, after screen sharing or other interactive software applications are present on a user's machine, enabling the interactive session could include a technical service provider or more than one technical service provider logging into the user machine.

Decision block 330 is directed to determining if a technical issue present on the machine is complex. Specifically, a complex issue could be one for which a technical service provider needs additional assistance. If not, block 340 provides for allowing a technical service provider to correct any issue with the user machine. Block 350 provides for determining if the issue is resolved. If the issue did not resolve, the determination at decision block 330 could be that the issue is complex. For complex issues, a technical service provider can consult the data store in block 360 and initiate peer analysis as shown in block 370. Either or both resources are available to a technical service provider. In one embodiment, a peer analysis can include connecting to a central location, such as control center 212 wherein a lead technical service provider or a core of technical service providers are located.

After using available resources, a determination is made in block 380 as to whether the issue with the machine has been resolved. If not, a user can be directed with further instructions that may include taking the machine to a physical location, which can include a store that is a partner, affiliate or organization under a plan for services.

Block 390 provides for updating data store 218 with issue resolution data. The updating can enable the neural network or artificial intelligence operating with data store 218 to enhance the data store to more quickly resolve a similar issue should a similar issue occur with another user. Additionally, the issue resolution data can be used to log data in the data store related to statistical analysis of the user experiences and occurrences of like issues, for example. The data can be generated automatically and/or can be provided via user feedback, such as a questionnaire or the like.

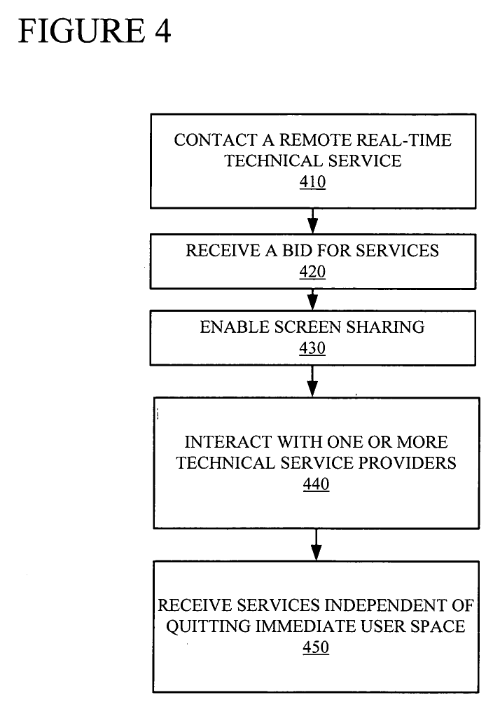

Referring now to FIG. 4, a flow diagram illustrates another method in accordance with an embodiment. More specifically, block 410 provides for contacting a remote real-time technical service. The contact can be over an internet connection or by telephone or the like. Block 420 provides for receiving a bid for services. A user of a machine requiring service can make a request and receive a bid for services. Block 430 provides for enabling screen sharing. Block 440 provides for interacting with one or more technical service providers, which can include screen sharing with one or several technical service providers. Interacting with one or more technical service providers could be via a broadband connection via screen sharing. The technical service providers could be connected via an internet connection using voice over IP technology and each technical service provider could have access to a data store holding technical information, the data store employing artificial intelligence, such as a neural network, to provide current technical information. Block 450 provides for receiving services independent of quitting an immediate user space. Receiving services independent of requiring a user to quit an immediate user space could include allowing the user to remain seated and interact with a machine requiring services, or allowing the user to remain within close proximity to a machine receiving services. The technical service providers can conference via one or more of a video conference, a telephone conference, and an online chat room with or without a connection to the user.

Another embodiment is directed to a system for providing remote near real time technical services, such as embodied in a server as shown in FIG. 2. In an embodiment, the system can include instructions to carry out the methods described above. More specifically, the system can include instructions for receiving a request for technical services; instructions for routing the request to a technical services control center; instructions enabling determining availability of one or more technical service providers for providing services; instructions enabling a real-time collaboration of the technical service providers according to the requirements of the request; instructions for searching a data store for a most likely solution appropriate for servicing the request; and instructions for updating the data store.

In one embodiment the system can further include instructions to enable a recording of servicing of the request, and instructions to enable a neural network to operate on data in the data store to enhance searching.

Another embodiment is directed to a computer system configured to enable remote near real time technical services. The computer system can include a module configured to receive requests for a remote real-time technical service; a module configured to prepare a bid for services; a module configured to determine if a machine associated with the request has appropriate interactive software enabled; and a module configured to enable the interactive software to couple one or more technical service providers with the machine associated with the request, the module configured to enable user making the request to receive services independent of requiring the user to quit an immediate user space.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for providing remote near real time technical services, comprising:
receiving a request for technical services;
routing the request to a technical services control center;
determining at the technical services control center availability of one or more technical service providers for providing services;
servicing the request via a collaboration of the technical service providers or an individual technical service provider according to the requirements of the request wherein the collaboration is via a near real time data link;
searching a data store for a most likely solution appropriate for the machine issue; and
after servicing a machine, updating the data store.

2. The method of claim 1, further comprising offering the user a recording of the session, the recording can include a DVD, a digital movie file transmitted via the Web or email.

3. The method of claim 1 wherein the data stored in the data store is updated in near real time, providing the technical service providers with the most up-to-date solution for the user issue.

4. The method of claim 1 further comprising:
applying artificial intelligence to data in the data store to enhance searching abilities and to create an intelligent data store upon each transaction with a user.

5. The method of claim 4 wherein the data store is a data store that self-updates and creates most likely scenarios based on the most current information available.

6. The method of claim 1 further comprising receiving a solution from the data store including all prior relevant data previously collected and stored;

7. The method of claim 4 wherein the artificial intelligence is a neural network.

8. A method for receiving remote near real time technical services, the method comprising:
contacting a remote real-time technical service requesting services;
receiving a bid for services;
if a computer requiring services is without screen sharing software, downloading and installing a computer agent to enable screen sharing;
interacting with one or more technical service providers via a broadband connection via screen sharing, the technical service providers being connected via an internet connection using voice over IP technology and each technical service provider having access to a data store holding technical information, the data store employing artificial intelligence to provide current technical information; and
receiving services independent of requiring a user to quit an immediate user space.

9. The method of claim 8 wherein the interaction between a user and the technical service provider is over an internet connection.

10. The method of claim 8 wherein the receiving services independent of requiring a user to quit an immediate user space includes one or more of allowing the user to remain seated and interact with a machine requiring services, allowing the user to remain within close proximity to a machine receiving services.

11. The method of claim 8 wherein the technical service providers conference via one or more of a video conference, a telephone conference, and an online chat room.

12. A system for providing remote near real time technical services, comprising:
instructions for receiving a request for technical services;
instructions for routing the request to a technical services control center;
instructions enabling determining availability of one or more technical service providers for providing services;
instructions enabling a real-time collaboration of the technical service providers according to the requirements of the request;
instructions for searching a data store for a most likely solution appropriate for servicing the request; and
instructions for updating the data store.

13. The system of claim 12 further comprising instructions to enable a recording of servicing of the request.

14. The system of claim 12 wherein the data stored in the data store is updated in near real time.

15. The system of claim 12 further comprising:
instructions to enable a neural network to operate on data in the data store to enhance searching.

16. The system of claim 12 wherein the data store self-updates and creates most likely scenarios based on the most current information available.

17. A computer system configured to enable remote near real time technical services, the computer system comprising:
a processor;
a memory coupled to the processor; and
one or more modules coupled to the memory and the processor, the modules including:
a module configured to receive requests for a remote real-time technical service;
a module configured to prepare a bid for services;
a module configured to determine if a machine associated with the request has appropriate interactive software enabled;
a module configured to enable the interactive software to couple one or more technical service providers with the machine associated with the request, the module configured to enable user making the request to receive services independent of requiring the user to quit an immediate user space.

18. The system of claim 17 wherein the receiving services independent of requiring a user to quit an immediate user space includes one or more of allowing the user to remain seated and interact with the machine associated with the request and allowing the user to remain within close proximity to the machine.

19. The system of claim 17 wherein the technical service providers conference via one or more of a video conference, a telephone conference, and an online chat room.
